(19) United States
(12) Patent Application Publication
(10) Pub. No.: US 2012/0169667 A1
(43) Pub. Date: Jul. 5, 2012

(54) ELECTRONIC DEVICE AND POWER CONTROL METHOD THEREOF

(75) Inventors: FAN-LIN LU, Shenzhen City (CN); XIN ZHAO, Shenzhen City (CN); RUEY-SHYANG YOU, Tu-Cheng (TW); XIAO-GUANG LI, Shenzhen City (CN); HAN-CHE WANG, Tu-Cheng (TW); KUAN-HONG HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/154,446

(22) Filed: Jun. 7, 2011

(30) Foreign Application Priority Data
Dec. 29, 2010 (CN) 201010612382.5

(51) Int. Cl. G06F 3/042

(52) U.S. Cl. 345/175

(57) ABSTRACT

An electronic device includes a main control system, a power key, a touch screen, and a touch screen control unit. The touch screen includes a plurality of infrared emitters, a plurality of infrared receivers and an infrared light grid comprising an infrared light beam passing through the power key. The touch screen control unit includes a scan controlling module, a detecting module, and a power controlling module. The scan controlling module periodically scans the infrared light beam passing through the power key. The detecting module determines whether a blocked time of the infrared light beam passing through the power key reaches a first predetermined time period. The power controlling module powers on or off the main control system when a time of blocking the infrared light beam passing through the power key being blocked reaches the first predetermined time period. A related method is also provided.

### BACKGROUND

1. Technical Field

The present disclosure relates to electronic devices and power control methods thereof, and particularly, to an electronic device with a touch screen and a power control method applied to the touch screen.

2. Description of Related Art

Many electronic devices equipped with touch displays still require that a mechanical button be pushed for powering on/off the devices, which can be inconvenient.

Therefore, what is needed is an electronic device and a power control method thereof to alleviate the limitations described above.

### BRIEF DESCRIPTION OF THE DRAWINGS

The components in the drawings are not necessarily drawn to scale, the emphasis instead being placed upon clearly illustrating the principles of an electronic device and a power control method thereof. Moreover, in the drawings, like reference numerals designate corresponding sections throughout the several views.

FIG. 1 is a schematic view of an electronic device in accordance with an exemplary embodiment.

FIG. 2 is a schematic view of an infrared touch screen of the electronic device of FIG. 1 in accordance with an exemplary embodiment.

FIG. 3 is a schematic view of an infrared touch screen of the electronic device of FIG. 1 in accordance with another exemplary embodiment.

FIG. 4 is a block diagram of the electronic device of FIG. 1, in accordance with an exemplary embodiment.

FIG. 5 is a flowchart of a power control method for electronic devices, such as the one of FIG. 1, in accordance with the exemplary embodiments.

### DETAILED DESCRIPTION

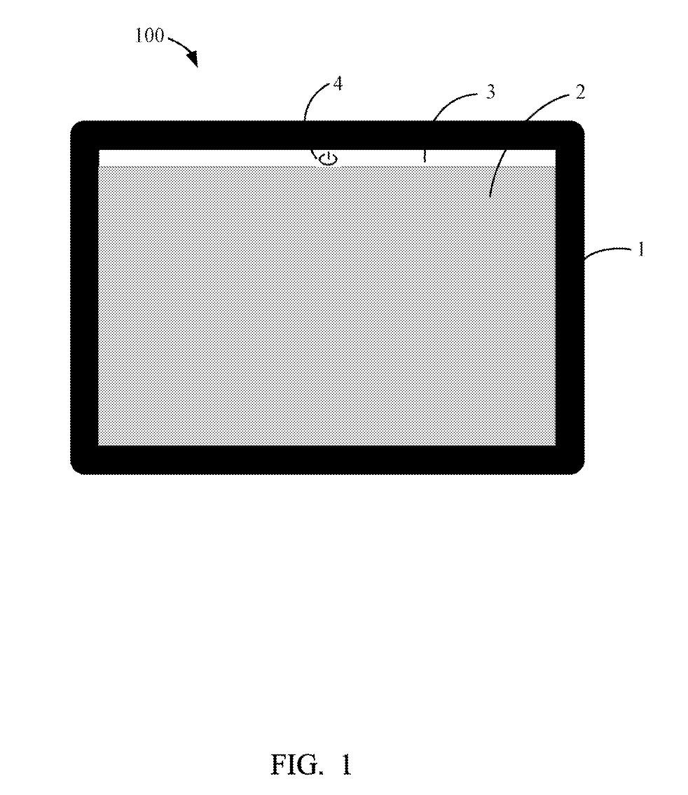

Referring to FIG. 1, an electronic device 100 is disclosed as an exemplary embodiment. The electronic device 100 includes a frame 1, a display 2, a touch screen 3, and a power key 4. In the embodiment, the touch screen 3 is an infrared touch screen, and overlaps the display regions of the display 2. The power key 4 is a power icon presenting itself on the upper middle of the touch screen 3. In other embodiments, the power key 4 is designed and allocated according to actual needs. For example, the power key 4 may be allocated in the lower middle or right corner of the touch screen 3, alternatively, the power key 4 may be a power icon located on a predetermined location on the frame 1.

In the embodiment, the electronic device 100 is a digital photo frame, in an alternative embodiment, the electronic device may be a mobile phone, an electronic reader, a music player, and other electronic devices equipped with infrared touch screens.

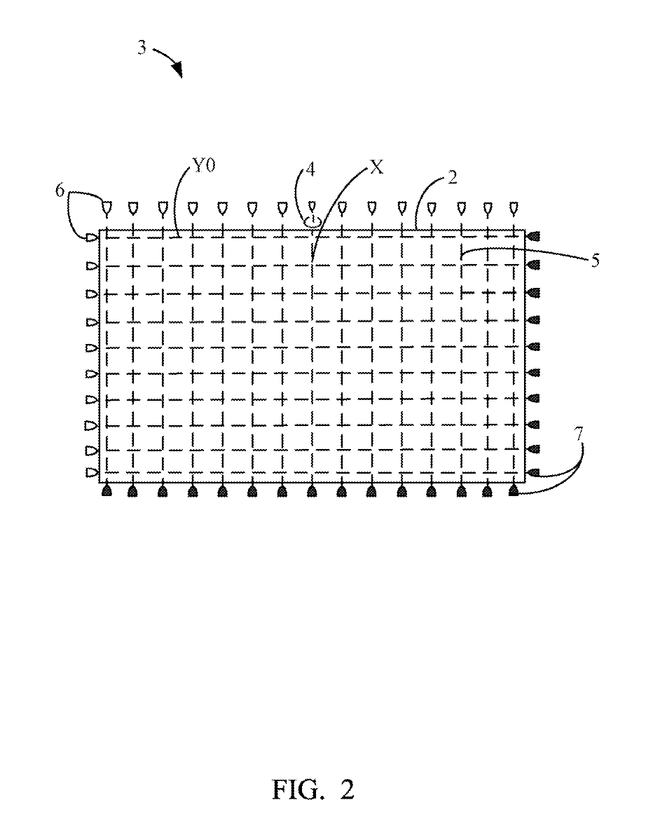

Further referring to FIG. 2, a schematic view of an infrared touch screen 3 of the electronic device of FIG. 1 is disclosed in accordance with a first embodiment. The touch screen 3 includes a number of infrared emitters 6 and a number of infrared receivers 7, which are all equipped in the frame 1. The infrared emitters 6 are distributed in two adjacent sides of the frame 1 and are equally spaced from each other. The infrared receivers 7 are distributed in the other two adjacent sides of the frame 1 and are equally spaced from each other. Each of the infrared emitters 6 emits infrared light beams to the corresponding infrared emitter 7; the light beams from the infrared emitters 6 form an infrared light grid 5 under the touch screen 3. The infrared light grid 5 includes a vertical infrared light beam X emitted from an infrared emitter 6. The infrared light beam X passes through the power key 4. Another infrared light beam Y0 perpendicular to the infrared light beam X is emitted from another infrared emitter 6. The infrared light beam Y0 is the nearest horizontal infrared light beam to the power key 4. There is no horizontal infrared light beam that passes though the power key 4. In other embodiments, the infrared light grid 5 is designed according to actual needs, as long as one infrared light beam passes through the power key 4. In detail, the infrared light beam passing through the power key 4 may be a vertical or horizontal light beam or an inclined light beam with any angle relating to the sides of the frame 1.

When the main body of the electronic device 100 is turned off, once the time period of a user touching the power key 4 or other regions of the touch screen 3 to block the infrared light beam X reaches a first predetermined time period, the main body of the electronic device 100 automatically turns on. And then, the electronic device 100 automatically turns off if the user touches the power key 4 or other regions of the touch screen 3 to block the infrared light beam X again and the time period of blocking the infrared light beam X reaches the first predetermined time period. The first predetermined time period may be a default setting or preset by the user, such as 3 seconds or 5 seconds. The main body of the electronic device 100 includes components of the electronic device 100 excepting the touch screen control unit 30 and the touch screen 3. In an alternative embodiment, the predetermined time periods of blocking the infrared light beam X to power on and power off the electronic device are different. When the electronic device 100 is powered on and the time period of blocking the infrared light beam X is shorter than the first predetermined time period, the electronic device 100 executes other functions such as page flipping, zooming, according to the design of the system of the electronic device 100.

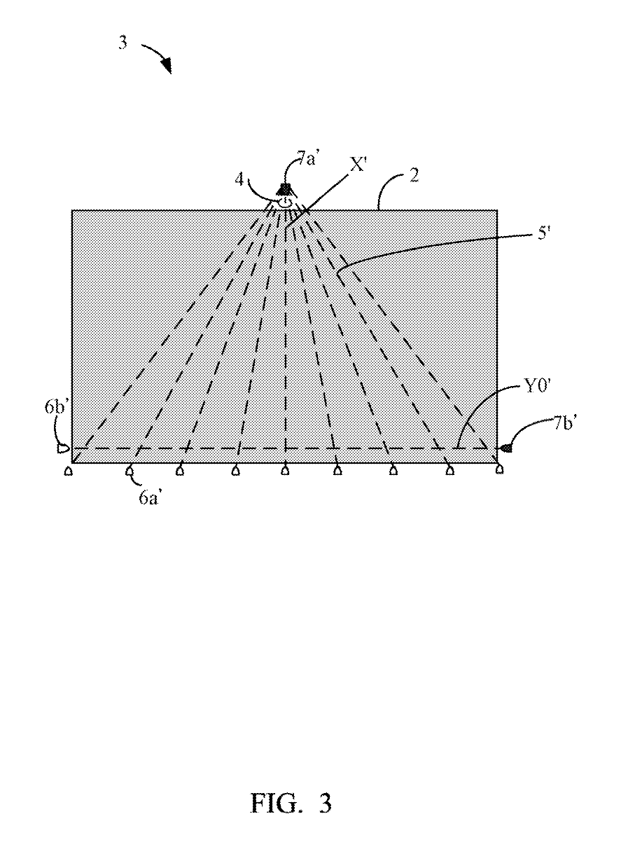

Referring to FIG. 3, a schematic view of an infrared touch screen 3 of the electronic device 100 of FIG. 1 is disclosed in accordance with a second embodiment. The difference between the second embodiment and the first embodiment is the arrangement of the infrared emitters and infrared receivers. In this embodiment, the infrared touch screen 3 includes a vertical infrared receiver 7a′ and a group of infrared emitters 6a′ that emit infrared light beams to the vertical infrared receiver 7a′. The infrared touch screen 3 further includes a horizontal infrared receiver 7b′ and an infrared emitter 6b′ that emits infrared light beams to the horizontal infrared receiver 7b′. Thus an infrared light grid 5′ is formed under the touch screen 3. The infrared light grid 5′ includes a vertical infrared light beam X′, and a horizontal infrared light beam Y0′ away from the power key 4.

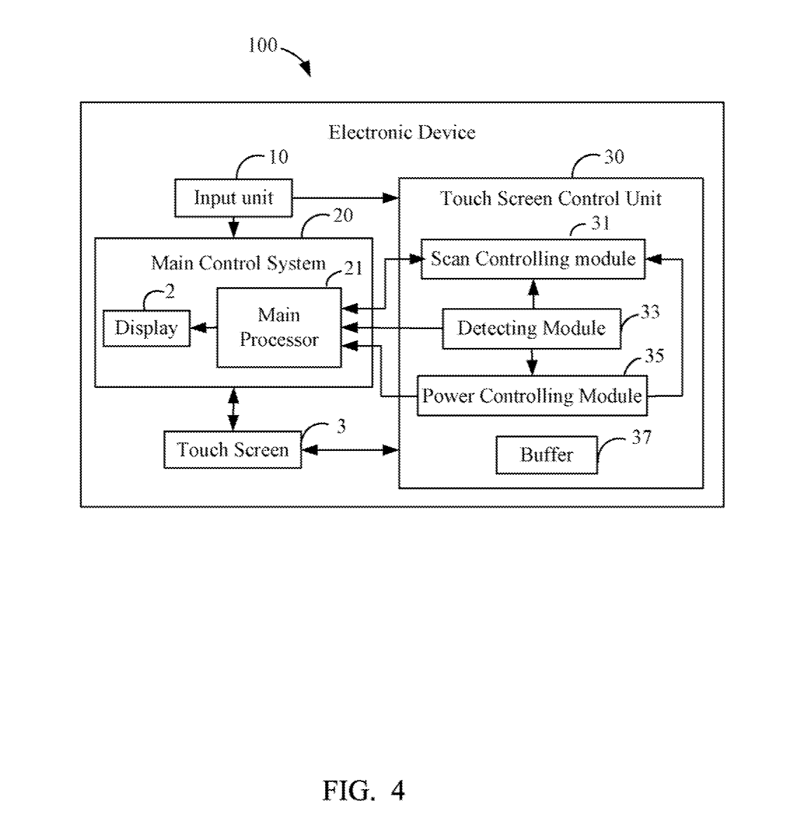

Referring to FIG. 4, the electronic device 100 includes an input unit 10, a main control system 20, a touch screen control unit 30, and a touch screen 3. The main control system 20 includes a main processor 21, the display 2, and other function components except the touch screen control unit 30 and the touch screen 3. In the embodiment, the main control system 20 forms the main body of the electronic device 100.

The touch screen 3 generates an infrared ray corresponding to the power key 4. The touch screen control unit 30 includes a scan controlling module 31, a detecting module 33, a power controlling module 35 and a buffer 37. The scan controlling module 31 continually scans the infrared ray corresponding to the power key 4. The detecting module 33 determines whether the time of the touch operation blocking the infrared ray (hereinafter “the blocked time”) corresponding to the power key 4 is longer than a first predetermined time period according to the detection results corresponding to a touch operation of a user. The power controlling module 35 turns on or off the power of the main control system 20 when the blocked time of the infrared ray corresponding to the power key 4 is longer than the first predetermined time period.

The touch screen control unit 30 and the touch screen 3 are powered by a power supply. In the embodiment, the power supply is a power supply circuit of the electronic device 100. In an alternative embodiment, the power supply is a mains adapter. In the embodiment, the power supply is an uninterrupted power supply; the main control system 20 is powered by another power supply different from the uninterrupted power supply. Powering on/off the main control system 20 does not affect the power supply of the screen control unit 30 and the touch screen 3.

The scan controlling module 31 is configured for executing different scan modes according to whether the main control system 20 is powered on. In the embodiment, the scan controlling module 31 executes an uninterrupted periodical scan on the full area of the infrared light grid 5 or 5′, when the main control system 20 is powered on. The scan controlling module 31 executes an uninterrupted scan only on the infrared light beam X or X′, when the main control system 20 is powered off. Therefore, whenever the main control system 20 is powered on or powered off, the scan controlling module 31 executes an uninterrupted scan on the infrared light beam X or X′ passing through the power key 4 all the time.

The detecting module 33 is further configured for detecting whether a touch operation exists and the touch location of the touch operation if the touch operation exists, according to the detection results transmitted from the scan controlling module 31. The detecting module 33 is also configured for transmitting the detection results to the scan controlling module 31, the power controlling module 35 and the main processor 21. In the embodiment, the scan controlling module 31 adjusts the scan frequencies on the touch screen 3 according to the detection results transmitted from the detecting module 33. On condition that the main control system 20 is powered on, the scan controlling module 31 reduces the scan frequency on the touch screen 3 when no touch operation exists on the touch screen 3 within a particular second predetermined time period (such as 60 seconds) according to the detection results transmitted from the detecting module 33, and the scan controlling module 31 further reduces the scan frequency when no touch operation exists on the touch screen 3 within another particular second predetermined time period (such as 5 minutes) according to the detection results transmitted from the detecting module 33. For example, when the touch screen 3 does not received a touch operation within 1 minute, the scan controlling module 31 halves the scan frequency on the touch screen 3, and if no touch after 5 minutes, the scan controlling module 31 further halves the scan frequency on the touch screen 3. Thus the electrical energy of the electronic device 100 is effectively saved.

In detail, the detecting module 33 is connected to the plurality of infrared receivers 7/7′, for detecting whether the infrared light beams are blocked according to whether the infrared receivers 7/7′ receive the infrared light beams accordingly. In the embodiment, the detecting module 33 detects each of the infrared receivers 7/7′ in turn to determine whether the touch screen 3 is touched, when the main control system 20 is powered on. The detecting module 33 only detects the particular infrared light beam configured for receiving the infrared light beam X/X′ to determine whether the power key 4 is touched, when the main control system 20 is powered off.

The detecting module 33 is further configured for detecting the blocked time of the infrared light beam X/X′, when the electronic device 100 is powered on.

The power controlling module 35 is configured for determining whether the electronic device 100 is powered off. The power controlling module 35 is further configured for receiving the detection results, and transmitting corresponding control signals to the main processor 21. In the embodiment, on condition that the main control system 20 is powered on, the power controlling module 35 transmits a power off control signal to the main processor 21 when the blocked time of the infrared light beam X/X′ passing through the power key 4 reaches the first predetermined time period (such as one second) according to the detection results transmitted from the detecting module 33. The main processor 21 receives the power off control signal and powers off the main controlling system 20. On condition that the main control system 20 is powered off, the power controlling module 35 transmits a power on control signal to the main processor 21 when the blocked time of the infrared light beam X/X′ passing through the power key 4 reaches the first predetermined time period (such as one second) according to the detection results transmitted from the detecting module 33. The main processor 21 receives the power on control signal and powers on the main controlling system 20.

With such configuration, the main control system 20 is powered on as long as the user touches the power key 4 for the first predetermined time period. And the electronic device 100 is powered on accordingly. The main control system 20 is powered off as long as the user touches the power key 4 for the first predetermined time period again. Thus, it is much convenience and friendly for the user.

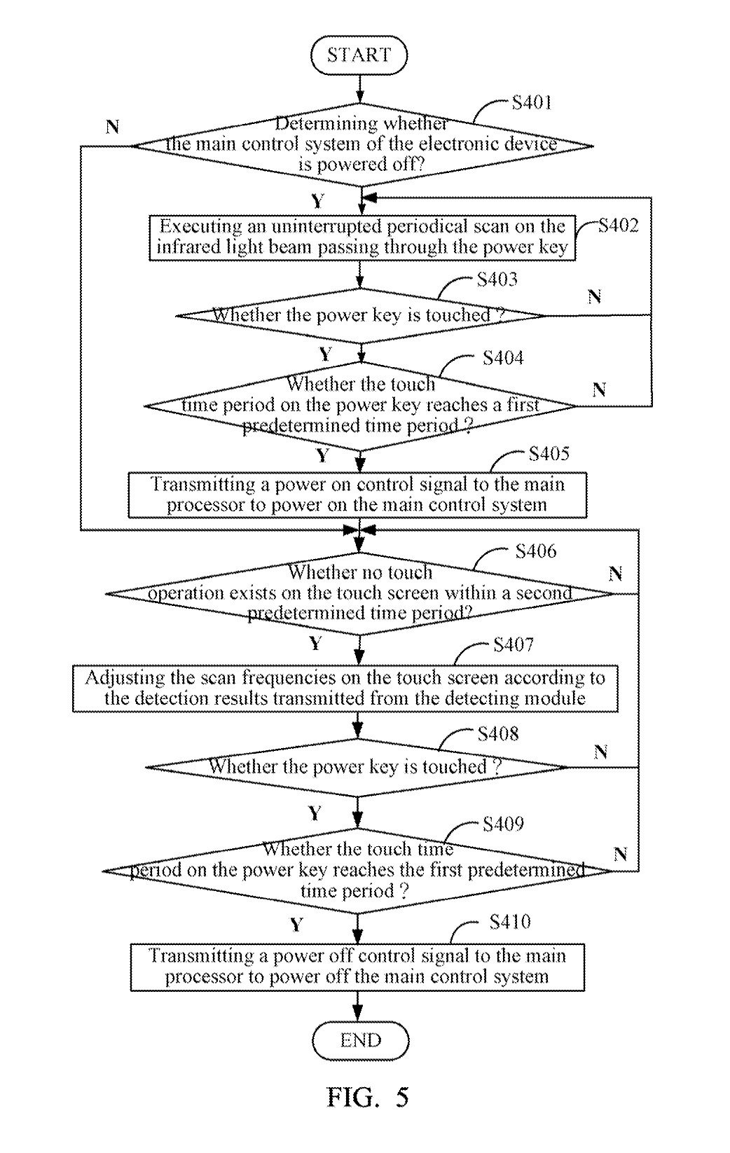

Referring to FIG. 5, a flowchart of a power control method for the electronic device 100 of FIG. 4 is shown. The method includes the following steps, each of which is tied to various components contained in the electronic device 100 as shown in FIG. 4.

In step 401, the power controlling module 35 determines whether the main control system 20 of the electronic device 100 is powered off, if yes, the process goes to step S402, otherwise, the process goes to step S406.

In step 402, the scan controlling module 31 executes an uninterrupted periodic scan on the infrared light beam X or X′ passing through the power key 4.

In step S403, the detecting module 33 determines whether the power key 4 is touched according to the detection results from the scan controlling module 31. If yes, the process goes to step S 404, otherwise, the process goes back to step S402. In the embodiment, the detecting module 33 determines whether the infrared light beam X or X′ is blocked according to the detection results of the infrared light beam X or X′, and determines whether the power key 4 is touched accordingly.

In step S404, the detecting module 33 determines whether the touch time period on the power key 4 reaches a first predetermined time period (such as one second), if yes, the process goes to step S405, otherwise, the step goes back to step S402.

In step S405, the power controlling module 35 transmits a power on control signal to the main processor 21 to power on the main control system 20.

In step S406, the detecting module 33 determines whether no touch operation has been performed on the touch screen 3 within a second predetermined time period, if yes, the detecting module 33 determines the touch screen 3 has been touched, and the processor goes to step S407, otherwise, the detecting module 33 determines the touch screen 3 has not been touched, and the process goes back to step S406.

In step S407, the scan controlling module 31 adjusts the scan frequencies on the touch screen 3 according to the detection results transmitted from the detecting module 33.

In step S408, the detecting module 33 determines whether the power key 4 is touched according to the detection results transmitted from the scan controlling module 31, if yes, the process goes to step S409, otherwise, the step goes back to step S406.

In step S409, the detecting module 33 determines whether the touch time period on the power key 4 reaches the first predetermined time period (such as one second), if yes, the process goes to step S410, otherwise, the step goes back to step S406.

In step S410, the power controlling module 35 transmits a power off control signal to the main processor 21 to power off the main control system 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device, comprising:
a main control system;
a power key;
a touch screen powered by a power supply, comprising a plurality of infrared emitters, a plurality of infrared receivers corresponding to the plurality of infrared emitters respectively, and an infrared light grid comprising infrared light beam passing through the power key; and
a touch screen control unit powered by the power supply, comprising:
a scan controlling module, and configured for periodically scanning the infrared light beam passing through the power key;
a detecting module configured for determining whether a blocked time of the infrared light beam passing through the power key reaches a first predetermined time period, according to detection results from the scan controlling module; and
a power controlling module configured for powering on or off the main control system when a time of blocking the infrared light beam passing through the power key reaches the first predetermined time period.

2. The electronic device as described in claim 1, wherein the infrared light beam passing through the power key is a vertical infrared light beam.

3. The electronic device as described in claim 1, wherein the detecting module is further configured for determining whether a touch operation exists on the touch screen within a second predetermined time period according to detection results transmitted from the scan controlling module, and the scan controlling module further reduces the scan frequency on the touch screen accordingly when no touch operation exists within the second predetermined time period.

4. The electronic device as described in claim 1, wherein the detecting module is further configured for detecting a time of the touch operation blocking the infrared light beam passing through the power key, when the electronic device is powered on.

5. The electronic device as described in claim 1, wherein the power supply is an uninterrupted power supply.

6. The electronic device as described in claim 1, wherein the power key is a power icon presenting on the touch screen.

7. The electronic device as described in claim 1, wherein the electronic device is a digital photo frame.

8. A power control method for an electronic device, the electronic device comprising a main control system, a power key, and a touch screen comprising a plurality of infrared emitters, a plurality of infrared receivers corresponding to the plurality of infrared emitters respectively, and an infrared light grid formed by infrared light beams between the infrared emitters and the infrared receivers, the infrared light grid comprising an infrared light beam passing through the power key, the method comprising:
executing an uninterrupted periodical scan on the infrared light beam passing through the power key;
determining whether a time of blocking the infrared light beam passing through the power key reaches a first predetermined time period, according to detection results; and
powering on or off the main control system when the time of blocking the infrared light beam passing through the power key reaches the first predetermined time period.

9. The method as described in claim 8, wherein the infrared light beam passing through the power key is a horizontal infrared light beam.

10. The method as described in claim 8, further comprises the steps of:
determining whether no touch operation exists on the touch screen within a second predetermined time period according to detection results; and
reducing a scan frequency on the touch screen accordingly when no touch operation exists within the second predetermined time period.

11. The method as described in claim 8, wherein the “powering” step further comprises the step of determining whether the main control system is powered on or powered off, and powering off the main control system if the main control system is powered on when the time of blocking the infrared light beam passing through the power key reaches the first predetermined time period, or powering on the main control system if the main control system is powered off when the time of blocking the infrared light beam passing through the power key reaches the first predetermined time period.

12. The method as described in claim 8, wherein the power key is a power icon presenting on the touch screen.
